(19) United States
(12) Patent Application Publication
(10) Pub. No.: US 2014/0158895 A1
(43) Pub. Date: Jun. 12, 2014

(54) PULSE-SHAPE DISCRIMINATION OF NEUTRONS USING DRIFT TUBES

(71) Applicant: Los Alamos National Security, LLC, Los Alamos, NM (US)

(72) Inventors: Zhehui Wang, Los Alamos, NM (US); Christopher L. Morris, Los Alamos, NM (US)

(21) Appl. No.: 13/936,019

(22) Filed: Jul. 5, 2013

Related U.S. Application Data
(60) Provisional application No. 61/668,344, filed on Jul. 5, 2012.

(51) Int. Cl. G01T 3/00

(52) U.S. Cl. CPC G01T 3/008
USPC 250/375; 250/382

(57) ABSTRACT

Apparatus and method for separating neutron-induced ⁴He (or other nuclei) recoil from background, which is predominantly gamma-ray induced electrons and cosmic rays, using software analysis of digitized electrical pulses generated in a six tube, high-pressure (11 bar) helium-4 (⁴He) detector, are described. Individual electrical pulses from the detector were recorded using a 12-bit digitizer, and differences in pulse rise time and amplitudes, due to different energy loss of neutrons and gamma rays, are used for neutron/gamma ray separation.

### CROSS-REFERENCE TO RELATED APPLICATIONS

The present application claims the benefit of U.S. Provisional Patent Application No. 61/668,344 for “Pulse-Shape Discrimination Of Neutrons Using High Pressure Helium-4 Drift Tubes” filed on Jul. 5, 2012, the entire contents of which application is hereby specifically incorporated by reference herein for all that it discloses and teaches.

### STATEMENT REGARDING FEDERAL RIGHTS

This invention was made with government support under Contract No. DE-AC52-06NA25396 awarded by the U.S. Department of Energy. The invention was also supported in part by the Defense Threat Reduction Agency (DTRA) of the Department of Defense. The government has certain rights in the invention.

### FIELD OF THE INVENTION

The present invention relates generally to neutron detection and, more particularly, to the detection of neutrons in the presence of other radiation pulses.

### BACKGROUND

Direct measurement of fast neutron energies can preserve the energy information of neutrons that is normally lost when using moderated neutron detection methods, such as helium-3 (³He) drift tubes or boron-10 (¹⁰B) detectors. Helium-4 (⁴He) atoms have one of the largest elastic scattering cross sections for 1-10 MeV fast neutrons; therefore, high pressure ⁴He detectors can deliver comparable or even higher efficiencies in detecting fast neutrons, including fission neutrons. A world-wide shortage of ³He has recently been recognized, and it is desirable to find a replacement for ³He used in portal monitoring of fission neutrons. It is possible to use high-pressure ⁴He drift chambers to replace moderated ³He portal monitors. In addition to direct fast neutron detection, other advantages of ⁴He detectors include non-toxic and inert gas use and the relative abundance of the ⁴He gas. However, many practical aspects of the high-pressure ⁴He detectors need to be addressed before they are field-deployable. One of the major issues is neutron/γ-ray discrimination, in particular when the γ-ray flux is large when compared with the neutron flux.

It is advantageous to use ¹H and ⁴He to measure fast neutron energy because large energy transfer is possible from a neutron to a ¹H (up to 100%) or a ⁴He nucleus (up to 64%) in one collision. On average, less than three collisions are needed to transfer 90% of initial neutron energy to a hydrogenous environment, and less than six collisions are needed in ⁴He. In the energy range between 1 to 10 MeV, the total elastic collision cross section of ⁴He(n,n)⁴He is about 1.3 (at 3 MeV) to 2.6 (at 1.2 MeV) times the total elastic cross section of ¹H(n,n)¹H. Differential cross sections give the distribution of energy transfer, which may be anisotropic for ⁴He(n,n)⁴He collisions for neutron energies of a few MeV. One can take advantage of the large hydrogen densities in plastic scintillators, organic scintillators or other ¹H-rich solids or liquids to achieve excellent intrinsic detection efficiency. As stated hereinabove, a main challenge is neutron/gamma (n/γ) discrimination, which has limited the material choices to NE-213 and a few others.

Three techniques of neutron/γ-ray discrimination exist: the rise-time analysis method, the gas-pressure method, and the double zero-crossing method. All three methods make use of the fact that Compton-recoil electrons, mostly coming from the wall of a detector because of the solid density there, have much larger range than recoil heavy ions (such as the a particle) for the same ionization and/or light production. In other words, the energy loss per unit length in gas is smaller by as much as three orders of magnitude for electrons than for heavy ions, including ⁴He nuclei. In the gas-pressure variation technique, the pressure of the gas is reduced until that the maximum electron range yields pulses of energy smaller than that of the proton recoils of interest. The double zero-crossing technique, used and described by Verbinsky and Giovannini, make use of bipolar pulses from a fast and a slow amplifier, providing a start and stop signal to a time-to-amplitude converter.

Measurement of neutron kinetic energy and energy distribution can be useful for distinguishing different sources of neutron emission, including fissile materials. Neutrons have a characteristic energy of 2.45 MeV from DD fusion, and 14.1 MeV from DT fusion. Neutrons from the ¹⁷N β-delayed decay have three characteristic energies at 1.70 MeV (7%), 1.17 MeV (50%), and 0.383 MeV (37%) respectively. Thermal neutron induced ²³⁵U fission emits fast neutrons with an average energy of about 2.1 MeV. Spontaneous fission from the radioisotope ²⁵²Cf emits neutrons with comparable average energies to those of ²³⁵U. For fissile material detection, not only the neutron energies, but also the fact that several fast neutrons and multiple γ-rays are emitted simultaneously is also of interest, in particular to background reduction and increased detection sensitivity. Since in coincidence measurements, the accidental rates can be reduced by narrowing the width of the coincidence window. Thermal ²³⁵U fission emits on average 2.5 neutrons and 6.6 γ-rays with an average energy of about 1 MeV. ²⁵²Cf emits about 3.8 neutrons and 8 γ-rays. Potential coincidence detection methods include neutron-neutron coincidence, neutron-γ coincidence, γ-γ coincidence and their combinations, all in conjunctions with measurements of neutron and γ-ray energies.

As stated hereinabove, the measurements are not always possible or straightforward. In addition to losses to nuclear reactions including absorption, MeV neutrons can lose their energies to the ambient very quickly through elastic collisions, a process usually known as neutron moderation. On average, the residual neutron energy after n elastic collisions with nucleii of mass A (in atomic mass unit) is given by Eₙ=E₀ exp(−nξ), with

$$ξ = 1 - \frac{{( A - 1 )}^{2}}{2 A} ln \frac{A + 1}{A - 1} .$$

For proton recoil, ξ=1. For large A, for carbon for example,

$$ξ \sim \frac{2}{A} .$$

In a common polyethylene plastic (CH₂) with a hydrogen density of 8.6×10²² cm⁻³ (mass density of 1 g/cm³), the mean free path of a 1 MeV neutron due to collisions with hydrogen atoms alone is about 2.7 cm, and 6.1 cm for 4 MeV neutrons. The corresponding time for neutron thermalization is on the order of 10 μs. The probabilistic nature of the collisions causes a spread in the time of thermalization from a few microseconds to tens of microseconds. Collisions also cause an artificial spread in detectable energy, even for a source that only emits mono-energetic neutrons.

In contrast to the slowing of neutrons, fission γ-rays interact with a detector mainly through Compton scattering, which spreads out the initial γ-ray energy both spatially and temporally. For large detectors having sufficiently long signal integration times, approximately the entire energy of an incident γ-ray is collected.

### SUMMARY OF THE INVENTION

Embodiments of the present invention overcome the disadvantages and limitations of the prior art by providing an apparatus and method for generating accurate measurements of fast neutrons.

Another object of embodiments of the present invention is to provide an apparatus and method for generating accurate measurements of fast neutrons from fissile materials.

Yet another object of embodiments of the present invention is to provide an apparatus and method for generating accurate measurements of fast neutrons in the presence of significant γ-ray fluxes.

Still another object of embodiments of the present invention is to provide an apparatus and method for generating accurate measurements of fast neutrons, in a robust, fieldable package.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

To achieve the foregoing and other objects, and in accordance with the purposes of the present invention, as embodied and broadly described herein, the apparatus for measuring neutrons in the presence of γ-radiation, hereof, includes: at least one gas drift tube, each of the at least one drift tubes having an anode, for detecting neutrons and generating electrical pulses on the anode thereof responsive to the neutrons; a charge-sensitive preamplifier for receiving electrical pulses from the at least one drift tube; a positive high voltage power supply for providing the bias to the anode of the at least one drift tube; a field-programmable gate array for receiving amplified electrical pulses from the preamplifier, and selecting chosen pulses; a waveform digitizer for receiving pulses chosen by the gate array, and digitizing the received pulses; and a processor for receiving and processing digitized pulses from the waveform digitizer, and for directing the gate array to receive electrical pulses; whereby pulse heights and rise times are generated from the digitized electrical pulses.

In another aspect of the present invention and in accordance with its objects and purposes, the method for measuring neutrons in the presence of γ-radiation, hereof, includes: biasing the anode of at least one gas drift tube responsive to the neutrons to a positive high voltage, such that electrical pulses are generated on the anode; amplifying the electrical pulses using a charge-sensitive preamplifier; selecting chosen amplified electrical pulses; digitizing the selected electrical pulses; and receiving and processing the digitized electrical pulses; whereby pulse heights and rise times are generated from the digitized electrical pulses.

Benefits and advantages of embodiments of the present invention include, but are not limited to, providing an apparatus and method for generating accurate measurements of fast neutrons in the presence of significant γ-ray fluxes.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings:

FIG. 1 is a schematic representation of an embodiment of the apparatus for analyzing pulses from a radiation detector, illustrating a helium-4 radiation detector, a signal pre-amplifier, a high-voltage source, a flash analog-to-digital converter (ADC) or other equivalent fast ADC techniques, and a computer for recording and analyzing the pulse information.

FIG. 2 is a graph comparing the required thicknesses of ⁴He and EJ301 liquid scintillators as a function of neutron energy deposition, for an average fission neutron of 2 MeV.

FIG. 3 is a graph illustrating examples of different pulses from a 10-bar ⁴He drift tube when using ORTEC 142PC preamplifier, the sharp rising pulse having a risetime of a few microseconds corresponds to a recoiling ⁴He particle, while the slower rising pulses having risetimes of ten microsecond and longer are Compton-scattered electrons.

FIG. 4 is a graph illustrating measured pulse rise time (equivalent to the charge collection time) as a function of drift time using cosmic rays, where a scintillator is used to measure the arrival of the cosmic ray.

FIG. 5 is a graph illustrating the comparison of mean stopping time of a recoil ⁴He particle and that of a Compton electron in 10-bar ⁴He gas, for energies up to 10 MeV, the mean stopping time for both types of particles being much shorter than the ion drift time over a distance of a few centimeters.

FIG. 6 is a two-dimensional map of pulse duration, T, vs. recorded pulse height, the two bands corresponding to electrons and alpha particles, respectively.

FIG. 7 is a graph of the energy spectrum from a drift tube that uses a small amount of ³He for energy calibration, the high-energy tail extending up to about 4.2 MeV being attributed to a particle emissions from ²³⁸U, a common contaminant in aluminum wall, and the model is based on a emissions from the wall without folding in the geometrical effect, which can enhance the lower energy part of the spectrum.

FIG. 8 is a graph illustrating a comparison of energy spectra for neutrons from ¹⁷N β-decay and a theoretical fit, the fit being a sum of two instrumental functions corresponding to mono-energetic neutrons at 1.17 MeV and 1.70 MeV respectively.

### DETAILED DESCRIPTION OF THE INVENTION

Embodiments of the present invention include an apparatus and method for a software-based pulse-shape discrimination for drift-tube detected neutrons based on direct digitization and recording of individual electrical pulses and subsequent post-recording analysis. Such analysis is possible as a result of recent advances in the field-programmable gate array (FPGA) control, fast analog-to-digital conversion, rapid data recording and fast transmission, and other related advances in information technology. Output signals (electrical pulses) from the drift tubes are amplified using a charge-sensitive pre-amplifier, and digitized. Pulse height information and rise time are then extracted from the digitized pulses in post processing. The signals correspond to Compton electrons and ⁴He recoil are found to be well separated, and consistent with simulations. Pulse-shape discrimination is generally unnecessary for drift tubes that use ³He gas since the neutron capture process ³He(n,p)T has a well defined energy peak at 0.764 MeV, which is also well separated from background. For detection schemes based on neutron scattering, however, the recoil charged particles have a continuous energy distribution ranging from zero to a maximum determined by the mass ratio of the recoil particle to the neutron. Good n/γ discrimination is therefore used for improved detection efficiency and accuracy. The present method preserves the maximum information associated with the detector response to a neutron and allows flexibility in data analysis and information extraction. The present inventors have found that it is possible to reduce the footprint of fast neutron spectroscopy significantly by integrating the FPGA control, pre-amplifier, and the post-processing chips and algorithms on a single circuit board.

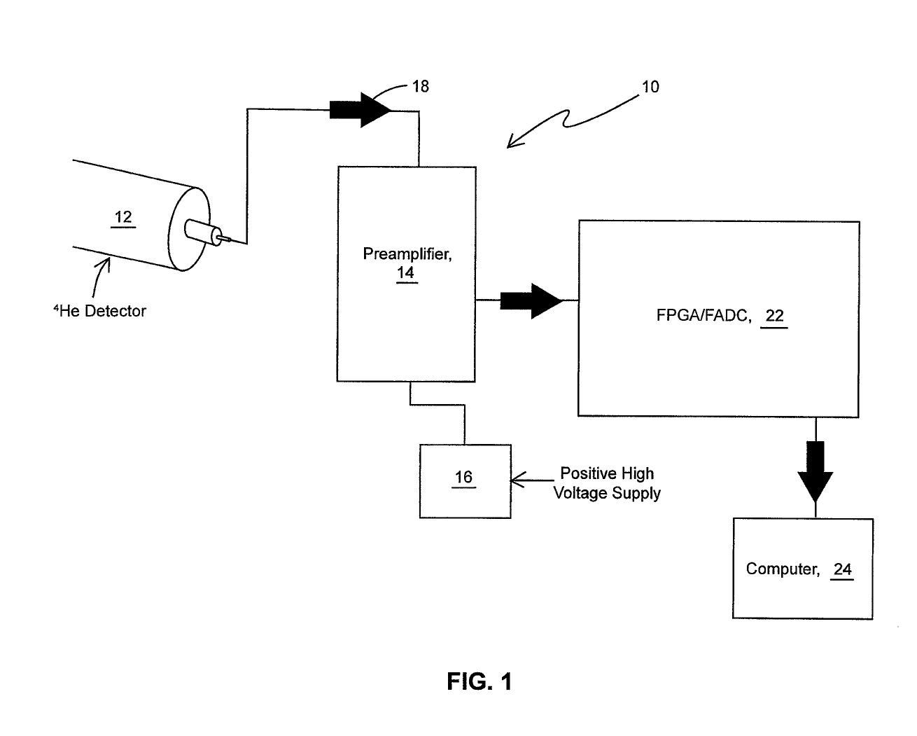

Reference will now be made in detail to the present embodiments of the invention, examples of which are illustrated in the accompanying drawings. In the FIGURES, similar structure will be identified using identical reference characters. It will be understood that the FIGURES are presented for the purpose of describing particular embodiments of the invention and are not intended to limit the invention thereto. Turning now to FIG. 1, a schematic representation of an embodiment of apparatus, 10, for analyzing pulses from a radiation detector is shown, illustrating a helium-4 radiation detector, a signal pre-amplifier, a high-voltage source, a flash ADC or direct conversion ADC, and a computer for analyzing the pulse information.

Drift tube, 12, is connected to the input of an ORTEC 142PC preamplifier, 14. The inputs of preamplifier 14 serve the dual functions of supplying positive high voltage bias (about 2 kV in this case), 16, to drift tube 12 through a SHV cable, and transmitting signal, 18, therefrom to preamplifier 14. The test port of the 142PC was used to measure the response function of the apparatus. The two outputs, one for time, and the other for energy, are equivalent for this measurement; the energy output was used. The output is connected to one of eight LEMO inputs on Field-Programmable Gate Array/Flash ADC (FPGA/FADC) board, 22. The additional frontend input of the FPGA/FADC board was used for firmware loading. One backend port was used for external clock, gating, timing/trigger and inhibit control. This function was not used for the present measurements. An internal clock was used. The output of the FPGA/FADC is transmitted through an Ethernet cable (RJ-45) to computer, 24. Computer 24 also sends commands to the FPGA/FADC board to record and transmit data.

A 10-bar ⁴He drift tube (plus 1 bar of other stopping gases) was used for the present fast neutron and γ-ray measurements, and to evaluate its technical potential for fissile material detection. The construction of the 10-bar ⁴He drift tubes is similar to the 1-bar ³He drift tubes described in the literature. The 2-in. diameter aluminum tubes used were 48 in. long. The anode was made of 30 mm gold-plated tungsten wire at a 50 g of tension. Torr-seal was used for gas sealing, the electrical shielding for the detector output was increased, and the detector capacitance was reduced using a SHV bulkhead connector. To ensure the tube tolerance to high pressure, a few tubes were randomly selected for hydrostatic testing to twice the gas pressure for about 10 min. The radius expansion was found to be less than a few thousandths of an inch, well within the expected elastic response of the material. In addition to 10-bar of ⁴He gas, 0.5 bar of Ar, 0.425 bar of CF₄ and 0.075 bar of C₂H₆ were also added to the gas mixture for improved particle response. The drift tubes were operated in the ionization mode for better energy resolution or proportional mode for higher gain. Most of the electric pulses from the anode, which are directly proportional to the recoil energy, were digitized after being amplified by the ORTEC 142PC preamplifier. The anode was biased at approximately 2.0 kV. No spectroscopy amplifier is used.

A 12-bit 250 MHz flash analog-to-digital converter (FADC) system was used for data acquisition. Other commercially equivalent FADC data acquisition can also be used for waveform digitization and recording. The incoming signal was continuously sampled with 12-bit resolution at a rate of up to 250 million samples per second by a Maxim MAX1215 flash ADC device. Each pair of flash ADCs was connected to a frontend Xilinx Spartan-3 (XC3S400-5C) field-programmable gate array (FPGA) that selects the samples of interest. The most commonly-used mode of operation was self-triggering, where “islands” of time corresponding to detector pulses are selected, typically including about 32 samples from before and after the time at which the signal exceeds a programmed threshold value. In this mode, each group of four samples is tagged with a 28-bit timestamp that allows 4.3 s of data to be collected between clock rollovers. For the maximum clock rate of 4 ns, 2²⁸ gives a rollover interval of 1.07 s. There were two additional ‘implicit’ clock bits based on the position of the four samples in the data stream. All timing was derived either from a 25 MHz (±30 ppm) crystal oscillator on the board or from an external clock input. Other modes of operation that have been demonstrated include an externally-triggered mode and a multichannel analyzer technique, where a histogram of pulse heights is collected and periodically transmitted. Since the buffer memories available on the board were small, data was quickly streamed over a 1000BASE-TX Gigabit Ethernet connection to a host computer, where it was archived and analyzed. Data selected by the triggering logic was passed through a first-in-first-out (FIFO) buffer in the 32 KiB (1 KiB=1024 byte) internal block RAM on the frontend FPGA. It was then transferred to the backend FPGA using a set of five differential pairs to minimize radiation of digital noise that might be picked up by the analog inputs. This process takes place at 25 MiB/s (1 MiB=1024 KiB) in the current system. The backend FPGA collects data from the four frontend FPGAs, which together serve eight input channels; it divides the data into packets and generates appropriate headers and checksums for Ethernet transmission. A custom Ethernet-level protocol provides for reliable detection of lost packets, although retransmission is not possible. The physical layer of the Ethernet connection is implemented by a National Semiconductor DP83865 device.

In what follows, the relative performances of high-pressure and liquid ⁴He detectors are compared with liquid scintillators EJ301 (NE-213) using a simplified analytical model. The pulse-shape discrimination in gas detectors based on different energy loss properties of n/γ is then described. As stated hereinabove, a six-tube detector (10-bar ⁴He drift tubes (plus 1 bar of other gases)) is used for fast neutron and γ-ray measurements, and its potential for fissile material detection is evaluated.

Typically, ⁴He recoil pulses have a relative short rise time of a few microseconds, determined by the total charge collection time by the anode wire, and limited by the pre-amplifier response time for the fastest rising pulses, which correspond to a recoil ⁴He moving parallel to the anode wire. The electron pulses due to Compton scattering at the wall have much longer time, typically on the order of tens of microseconds. A measured electric pulse (also referred to as a waveform) is a convolution between the charge collection as a function of time at the anode wire and the instrumental function. The instrumental function may be obtained by using calibration pulses from a pulse generator. One may also model the pulse rise time limit due to the preamplifier circuit plus the cables with a decay time constant of τ=RC and a short rise time constant τᵣ, with τᵣ<τ.

### A. Comparison of ⁴He and CHₓ Detectors:

The detection efficiency can be described by:

$$Ξ = \frac{S {ɛ}_{eff}}{4 π {z}^{2}} , \qquad ( 1 )$$

the product of the intrinsic efficiency (ε_{eff}) and the solid angle subtended by a detector

$$( \frac{S}{4 π {z}^{2}} )$$

with respect to a point n/γ source. Here S is the detector area, and z the distance between the detector and the source. From Eq. (1), one can obtain the required amount of mass corresponding to ξ is:

$${M}_{eff} = ρ Sl = 4 πρ {lz}^{2} \frac{Ξ}{{ɛ}_{eff}} . \qquad ( 2 )$$

where l, the detector thickness, depends on the intrinsic efficiency ε_{eff} and vice versa. ρ is the mass density. The detector size and mass requirements are based on energy deposition; that is, the average number of collisions of a neutron or a γ-ray experience before escaping from the detector. The criteria for the detector size and mass requirements change if other detection mechanism, such as momentum measurement, is used. The detection of neutrons with an initial energy 2 MeV, which is with an average energy of nuclear fission is investigated. Multiple Compton scattering of γ-rays can be found in previous works and will not be repeated.

In the thin detector approximation, or single-neutron scattering regime, ln σ<<1, ε_{eff}=1−e^{-nσl}˜nσl, the detector mass requirement reduces to:

$${M}_{eff} = ρ Sl = 4 πρ l {z}^{2} \frac{Ξ}{{ɛ}_{eff}} = 4 π {M}_{0} {z}^{2} \frac{Ξ}{σ} , \qquad ( 3 )$$

σ is the total elastic scattering cross section. For ⁴He, M₀=4M_{AMU} is the mass of ⁴He atom, for CHₓ,

$${M}_{0} = \frac{12 + x}{x} {M}_{AMU} .$$

For EJ-301 (NE-213), x=1.212. At 2 MeV neutron energy, the total elastic collision cross sections are 2.904 and 3.980 barns for hydrogen and ⁴He respectively. Therefore, for comparable detector performance,

$$\frac{{M}_{eff} ( {CH}_{x} )}{{M}_{eff} ( {}^{4} He )} = \frac{12 + x}{4 x} \frac{σ ( {}^{4} He )}{σ ( {}^{1} H )} \sim 3.7 , \qquad ( 4 )$$

which is basically the molecular weight ratio divided by the cross section ratio. Neutron collisions with carbon nucleii in CHₓ are neglected since a single collision between a fast neutron and a carbon nucleus can only result in negligible energy deposition, and thus no signal generation in the detector.

Since ⁴He detectors can come in the forms of high-pressure ⁴He gaseous detection systems based on charge collection or gas scintillation, a liquid ⁴He scintillation system (0.125 g/cm³, which is equivalent to the density of gaseous ⁴He at 700 bar of pressure and room temperature). NE-213 or EJ-301 (density 0.874 g/cm³, H:C=1.212, nₑ:n_{H}:n_{C}=2.27×10²³:4.82×10²²:3.98×10²² per cm³) is normally used as liquid scintillator detectors. Therefore, a liquid helium or a 700 bar ⁴He gas detector should be about 1.9 times the volume of a EJ-301 detector for comparable detection efficiency for 2 MeV neutrons. A 10 bar ⁴He gas detector, by contrast, must have a volume about 130 times the volume of an EJ-301 detector for the same efficiency.

In the thick detector limit, or the multiple neutron scattering regime, ε_{eff}˜ε₀. Here ε₀ is the ideal efficiency of a semi-infinite detector. A neutron, which enters from the air into the detector, still can be reflected back into the air and is lost. Therefore ε₀<1, and can be estimated as follows. In the Laboratory frame, the scattering angle of a neutron collision with a nucleus (θ_{L}) is given by:

$$cos {θ}_{L} = \frac{A cos θ + 1}{{A}^{2} + 1 + 2 A cos θ} , \qquad ( 5 )$$

here θ is the angle in the CM frame. For simplicity, assume that the neutron enters the semi-infinite detector at the normal incidence and therefore only when A>1, the neutron will be reflected back to the air. To zeroth order, a neutron escapes when it does not collide again on the way out. The probability of reflection loss is thus given by

$$1 - {ɛ}_{0} = \frac{1}{2} {\int }_{0}^{∞} {e}^{- n σ z} n σ d z {\int }_{{θ}_{0}}^{π} {e}^{z \text{/} ( \overline{λ} cos {θ}_{L} )} sin θ d θ , \qquad ( 6 )$$

where nσ is for ⁴He or carbon. λ̅⁻¹=nσ in ⁴He. λ̅⁻¹=nσ+n_{H}σ_{H} in CHₓ. θ₀ is given by cos θ₀=−1/A. Integrating over z first and then numerically solving the integral, one obtains ε₀=0.89 and 0.75 for ⁴He and CHₓ, respectively, for 2 MeV neutrons. Considering the thickness l as a function of ε, the efficiency corresponds to when a neutron deposits certain amount of its initial energy (2 MeV) in the detector. Since neutron slowing in matter is stochastic nature, only an ‘average’ neutron is considered. After each collision, the neutron is left with e^{-ξ} times the energy before the collision. ξ=0.425 in ⁴He and ξ=1 in CHₓ (neglecting the energy loss due to collisions with carbon). Assuming isotropic scattering in the CM frame, the average recoil angle (θ_{L}) in the Laboratory frame is given by <cos θ_{L}>=2/(3 A), or 48.2 degrees in CHₓ, and 80.4 degrees in ⁴He. The average mean free-paths during the slowing down can then be calculated using the correspondingly cross sections as listed in TABLE 1, where mean neutron slowing-down cross sections are used to compare relative performance of a ⁴He based neutron detector and CHₓ-based neutron detector.

TABLE 1

| | CHₓ | | ⁴He | |
|---|---|---|---|---|
| | E (MeV) | σ (barn) | E (MeV) | σ (barn) |
| 0 | 2 | 2.904 | 2 | 3.980 |
| 1 | 0.736 | 5.007 | 1.307 | 6.958 |
| 2 | 0.271 | 8.448 | 0.854 | 5.134 |
| 3 | 0.1 | 12.74 | 0.558 | 1.780 |
| 4 | 36.6 × 10⁻³ | 16.6 | 0.365 | 1.034 |
| 5 | 13.5 × 10⁻³ | 18.8 | 0.238 | 0.848 |
| 6 | 4.9 × 10⁻³ | 19.8 | 0.156 | 0.793 |

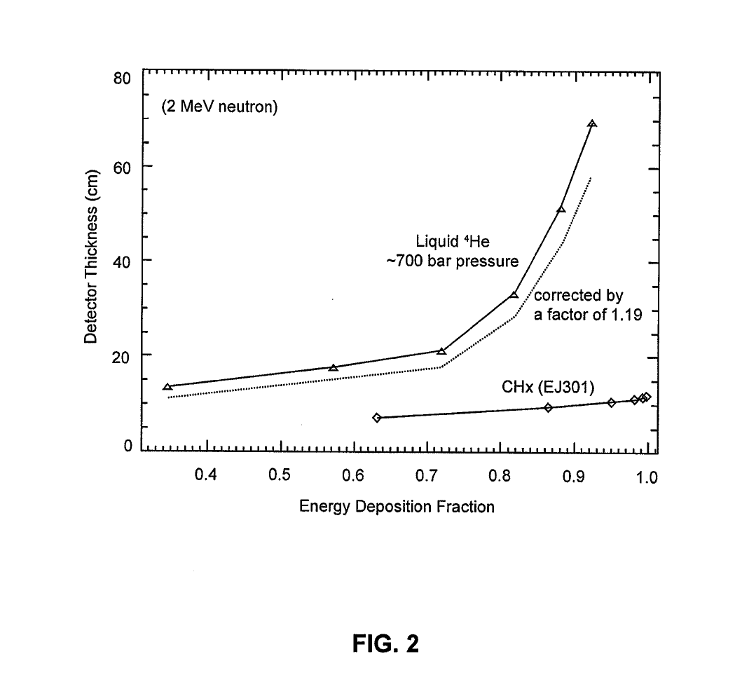

The following model is used to calculate l:

$$l = {λ}_{0} + \frac{1}{\sqrt{3}} \sqrt{{\sum }_{i = 1}^{N} {λ}_{i}^{2} + 2 {\sum }_{i = 1}^{N - 1} {\sum }_{j = i + 1}^{N} {λ}_{j} {λ}_{j} < cos {θ}_{L} {>}^{j - i}} , \qquad ( 7 )$$

where λᵢ is the mean-free path after ith collision. We have taken these factors into account: 1.) Incoming neutron direction is not random; 2.) Neutron mean free path changes after each collision; 3.) The factor of 1/\sqrt{3} represents the distance project of a 3-D isotropic diffusion onto one direction. The result for l as a function of neutron energy extraction is shown in FIG. 2. The changes in thickness CHₓ as a function of energy deposition are small, reflecting the facts that the cross section of ¹H(n,n)¹H increases as neutrons slow down and nearly equal mass between hydrogen and neutron. For ⁴He detectors, when neutron energy drops below 0.5 MeV, the energy deposition becomes inefficient and significantly thick ⁴He would be needed to extract the residue neutron energy. However, a full neutron energy extraction is not necessary for many applications, including fissile material detection. The difference of ε₀ as mentioned above gives a small correction of 1.19 to size requirement. In terms of the relative mass for 50% energy extraction (˜1 MeV off a 2 MeV neutron), the required helium mass can be 25% to 50% less than that of a liquid scintillator. Since ⁴He has lower number density than EJ301, it is clear that the ⁴He detector volume could be significantly larger, and a report stated that high-pressure gas detectors were tested at approximately 500 bar pressure.

### B. Data Analysis, Results and Discussion:

1. Recording of Individual Particle Events:

Individual charged particle tracks due to Compton electrons or recoil ⁴He nucleii turn into a time-dependent current signal I(t) on the anode wire. The advantage of a waveform digitizer, compared with a conventional scaler or a multichannel analyzer (MCA), is that I(t) or the charge collection as a function of Q(t), rather than their time integrals, is recorded. I(t) or Q(t), which are functions of the stopping power of particles dE/dx, can be used for particle identification while their time integrals alone cannot. The disadvantage of a waveform digitizer is its demand for higher data transmission rate (bandwidth) and large storage space. It was found that each board was limited to a maximum waveform-recording rate of between about 20 kHz and approximately 50 kHz with a waveform length of about 500 data points and an Ethernet bandwidth of 100 MHz. However, the transmission bandwidth problem can be improved by implementing waveform analysis firmware through the FPGA and reducing the amount of data that needs to be transmitted. This option was not exercised in this work, since raw I(t)'s are normally too small to be digitized and recorded directly (the smallest bit corresponds to about 1 mV here); therefore, they are first amplified. A variety of amplification plus digitization schemes are possible. One is the direct digitization of the output from an ORTEC 142PC charge pre-amplifier, as was used for the present measurements. Other methods generally require further processing of the outputs from the ORTEC 142PC through either hardware, such as an ORTEC 474 timing filter amplifier, or software. Such additional signal processing will likely result in better quality data, as will be discussed below, but the benefits are expected to be small for the present measurements.

As stated hereinabove, an ORTEC 142PC is used for the present measurements since the anode signals are on the order of 10⁶ electrons. The large input impedance, coupled with small parasitic capacitance with careful arrangement of the apparatus, permits these preamplifiers to function at a few hundred electrons noise level, which approaches the thermal or Johnson noise at room temperature. The statistical (Poisson) fluctuation of the signals of ˜10⁶ electrons also produces noise on the same order of magnitude. For the present measurements, the mean rise time constant of the ORTEC 142PC was found to be about 0.148 μs, and the decay time constant was 21.5 μs, both consistent with manufacturer specifications. The deviation from pulse to pulse was found to be about 10%, and the integration time of 21.5 μs is sufficiently long for most of the recoil ⁴He particles.

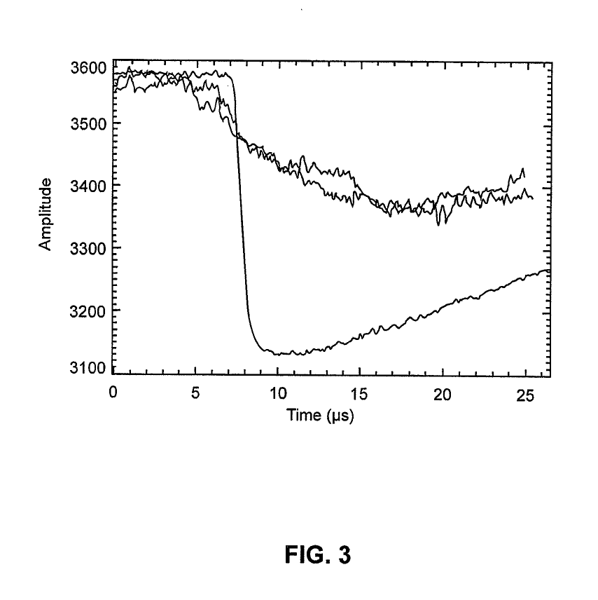

Examples of the waveforms using ORTEC 142PC are shown in FIG. 3. Typically, ⁴He recoil pulses have a relative short rise time of a few μs, determined by the total charge collection time by the anode wire, and limited by the pre-amplifier response plus charge diffusion time for the fastest rising pulses, which correspond to a recoil ⁴He moving parallel to the anode wire. The electron pulses due to Compton scattering at the wall have longer time above 10 μs.

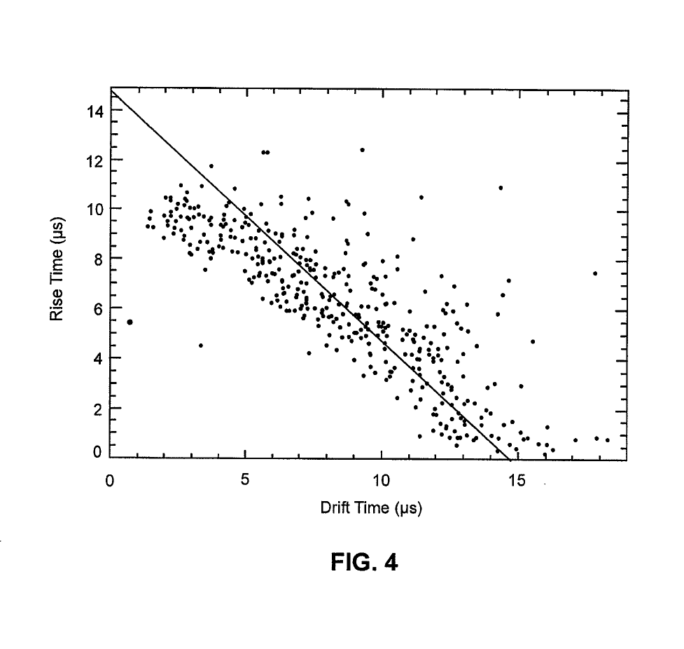

The drift time and charge collection were measured directly using cosmic rays, the results being presented in FIG. 4. A thin plastic scintillator was used to measure the pulse arrival time. The drift time (τ_{d}) is the time interval between scintillator pulse and the start of a drift tube pulse, which is defined as the time when the pulse amplitude rises to 10% of the full peak. The rise time (τᵣ) is extracted from each pulse by subtracting the time at 10% peak amplitude level from the time at 90% of the peak amplitude. The rise time is a measure of track length projected radially in a cylindrical drift tube; that is, the direction that is perpendicular to the anode wire.

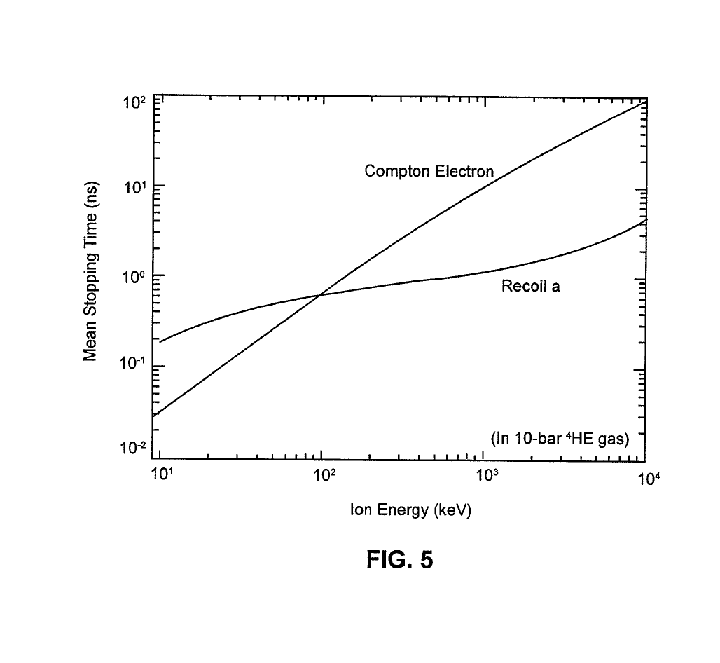

The slowing-down of Compton electrons or recoil alpha particles may be regarded as instantaneous with respect to the drift time, as may be observed in FIG. 5. The slowing down time (ΔT_{SL}) can be estimated as follows,

$$Δ {T}_{SL} = \int {( \frac{d E}{d l} )}^{- 1} \frac{d E}{β c} ,$$

where dE/dI is the energy loss of the recoil particles per unit length, β is the ratio of the particle speed to the speed of light. The recoil energies of interest are up to 10 MeV. This approach estimates the mean values of ΔT₀ and neglects energy straggling. Due to energy straggling, even for identical initial conditions, two recoil particles can deposit different amount of energy and may have different deposition time ΔT₀. SRIM was used to calculate dE/dI for ⁴He recoil, and the ESTAR database maintained by NIST to calculate dE/dI for Compton electrons. A result is shown in FIG. 5. The mean stopping time for both types of particles is much shorter than the ion drift time over a distance of a few centimeters. Therefore, the pulse rise time is dominated by the ion drift time and charge collection time for both particles, which are discussed next.

These results may be explained by the classical kinetic theory of gases and charge particle drift motion inside a radial electric field. The fitting curve based on this model is shown in FIG. 4, and fits the observation. The electric field due to the anode bias V₀ is given by E(r)=V₀/[ln(R₀/r₀) r], with R₀=25.4 mm being the inner radius of the detector and r₀=30 μm being the anode wire radius. Therefore for a 2 kV bias, E(r)=2.97×10²/r in V/cm for a radius r in cm. The drift velocity varies slightly due to the 1/r-dependence of the electric field. For each neutron or Compton electron induced signal, the drift time is given by

$${τ}_{d} = {\int }_{r 0}^{r 1} \frac{d r}{{u}_{d}} ,$$

where the integration is from approximately the radius of the anode wire to the minimum radius of the particle track (r₁). Using The electron drift velocity u_{d}=eE/(mₑv), and

$${τ}_{d} = {τ}_{0} ( \frac{{r}_{1}^{2}}{{R}_{0}^{2}} - \frac{{r}_{0}^{2}}{{R}_{0}^{2}} ) \sim {τ}_{0} \frac{{r}_{1}^{2}}{{R}_{0}^{2}}$$

for r₀<<r₁. Here the characteristic time τ₀ is defined as:

$${τ}_{0} = \frac{{m}_{e} {R}_{0}^{2} v ln \frac{{R}_{0}}{{r}_{0}}}{2 e {V}_{0}} .$$

Similarly, the rise time is given by

$${τ}_{r} = {τ}_{0} ( 1 - \frac{{r}_{1}^{2}}{{R}_{0}^{2}} ) .$$

The drop of the measured rise time from the fitting curve may be noticed for small drift times. The most likely cause is the finite integration time of the pre-amplifier (21.5 μs). The coincidence requirement between the drift tube signal and the scintillator prevented observation of alpha particle signals due to the wall emission. In addition, the fit gives a measured value τ₀ of 14.7 μs from the wall, which is in a good agreement with 14.0 μs, predicted by Garfield simulations for a drift distance of 25.4 mm and a ⁴He pressure of 10 bar.

2. n/γ Separation Based on Different Stopping Power dE/dI:

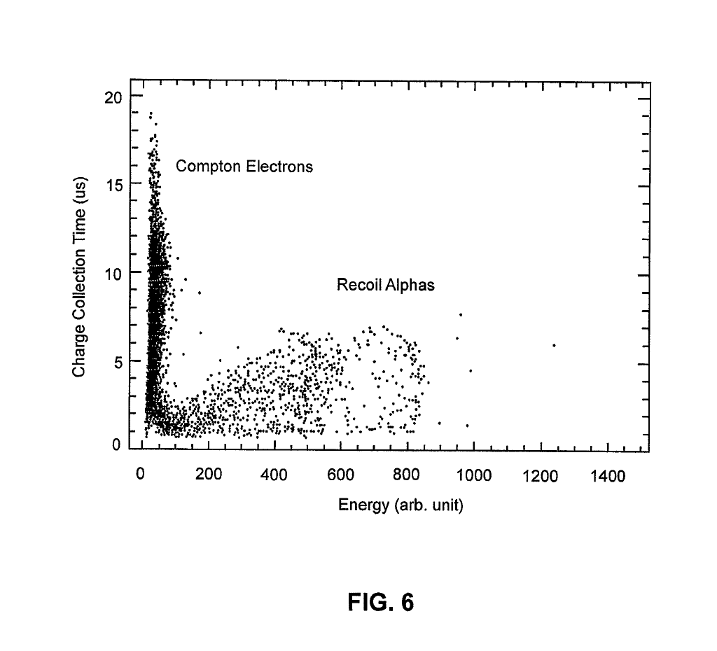

A two-dimensional map of the pulse rise time τᵣ vs. the pulse height is shown in FIG. 6. The two well separated particle bands correspond to Compton electrons and recoil α particles in the drift tube respectively. Furthermore, when a γ source was placed near the detector, the increase of counts in the electron band was clearly observable with negligible contributions to the α particle band. It should also be pointed out that the background in the a particle bands may derive from residual a particle radiation from the wall material. For the present measurements, the background signals including cosmic ray were not high enough to be of a concern.

Different stopping power (dE/dI) for Compton electrons and heavy ions like ⁴He can be used to explain the observed separation. As stated hereinabove, pulse-shape discrimination is normally not necessary for drift tubes that use ³He gas since the neutron capture process ³He(n,p)T has a well defined energy peak at 0.764 MeV, which is also well separated from background. For detection schemes based on neutron scattering, however, the recoil charged particles have a continuous energy distribution ranging from zero up to a maximum determined by the mass ratio of the recoil particle to the neutron. Good n/γ discrimination is necessary for obtaining the best detection efficiency and accuracy.

In the MeV energy range, electrons are relativistic while ions are not. The differences in energy loss per unit length, dE/dI, are well known. The ratio of energy loss per unit length of a relativistic electron βₑ˜1) to that of an ion (βᵢ<<1) is proportional to (βᵢ/βₑ)²˜10⁻³, independent of the mass density of stopping medium. Gas detectors have low mass density. In a drift tube, n/γ can interact with the gas and the wall. In the γ-ray energy range of 0.1 to 1 MeV, the primary interactions with ⁴He and ²⁷Al is Compton scattering. The Compton scattering cross sections are 0.1478 and 0.0636 cm²/g at 0.1 and 1 MeV respectively in ⁴He. In ²⁷Al, the Compton scattering cross sections are 0.1388 and 0.0613 cm²/g at 0.1 and 1 MeV, respectively. The mass density of ⁴He is 1.78×10⁻³ g/cm³ at a pressure of 10 bar and room temperature. Therefore, the Compton scattering probability in 1 cm pathlength in ⁴He (10 bar) is equivalent to 7 μm in ²⁷Al for 0.1 MeV γ-ray, and 6.8 μm in ²⁷Al for 1 MeV γ-rays. The continuous slowing down approximation (CSDA) ranges of electrons in ²⁷Al are 0.01872 g/cm² and 0.5546 g/cm² for 0.1 and 1 MeV, or 69 μm and 2054 μm of distance in ²⁷Al. Therefore, when a γ-ray impinges on the detector, it could generate a Compton electron from the near side of the ²⁷Al wall, inside the ⁴He gas, or from the far side of the wall. The far-side is unlikely to induce any detectable signal since the Compton electrons are more likely forwardly moving into the wall. Higher the γ-ray energy (>1 MeV), more likely the Compton electrons will come from the wall. The relative fraction of the Compton electrons due to ⁴He increases for lower energy γ-rays.

Similar to γ-rays, neutrons can also produce recoil ²⁷Al (up to 13.8% of the neutron energy) from the near-side wall and recoil ⁴He inside the gas. The relevant wall thickness is much smaller than that of electrons since MeV ⁴He or ²⁷Al nuclei can penetrate no more than a few microns thickness of ²⁷Al. Inside the gas, the distances of recoil ⁴He or ²⁷Al are also less than diameter of the detector (5 cm in this case). For example, the ranges of 1 MeV, 4 MeV, and 10 MeV ⁴He are 1, 4, and 14 mm, respectively.

It is convenient to implement the n/γ discrimination through software, as is done in embodiments of the present invention to generate FIG. 6. Output signals (electrical pulses) from the drift tubes are amplified using a charge-sensitive pre-amplifier and digitized. The pulse height information and the rise time are then extracted from the digitized pulses in post processing. The signals correspond to the Compton electrons and the ⁴He recoils are found to be well separated, consistent with simulations.

3. Energy Spectrum Analysis:

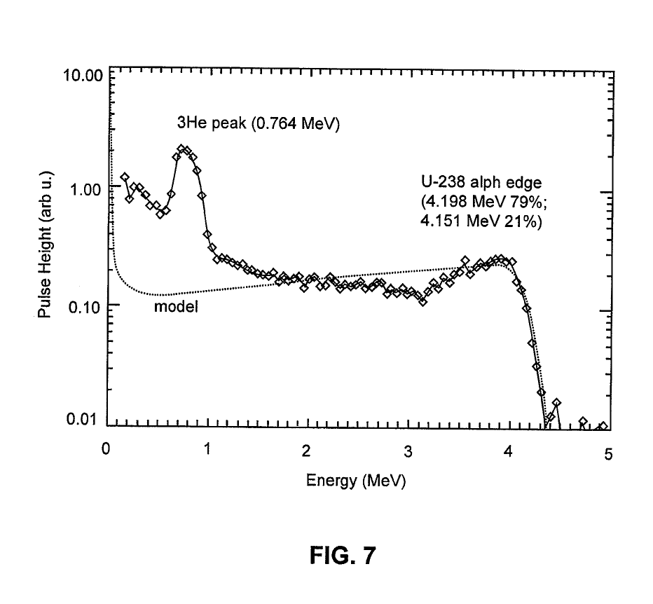

The energy scale was calibrated by adding a trace amount (10 to 30 mbar) of ³He to the gas mixture. The data for a single 48-in. long drift tube is shown in FIG. 7. A common feature to all energy spectra is a high energy tail extending up to about 4.2 MeV. This tail is attributed to a particle emissions from ²³⁸U, a common contaminant in aluminum. Based on SRIM calculations, a 4.2 MeV a particle has a range about 17 μm in aluminum, much greater than the natural oxidation layer of aluminum (up to 0.1 μm). The energy spectrum of the wall a particles, dN/dE, may be explained by the following model,

$$\frac{d N}{d E} = \frac{d N}{d X} {( \frac{d E}{d X} )}^{- 1} ,$$

where X is the total path-length of an α particle within aluminum. We have neglected energy straggling here, therefore E is a monotonic function of X and vice versa; that is,

$$E = {E}_{0} - {\int }_{0}^{X} \frac{d E}{d y} d y .$$

Here, E₀ is the initial a particle energy. Next, it is assumed that a particles are emitted homogeneously from the wall, with a uniform density of n₀, then

$$\frac{d N}{d X} = {\int }_{0}^{X} π ( {R}_{0} + y ) {Ln}_{0} \frac{y}{{X}^{2}} d y = \frac{π {R}_{0} {Ln}_{0}}{2} ( 1 + \frac{2}{3} \frac{X}{{R}_{0}} ) .$$

Since X<20 μm, dN/dX, to the zeroth order, is a constant that only depends on the overall dimensions of the detector, length L and inner tube radius R₀. Therefore,

$$\frac{d N}{d E} = \frac{π {R}_{0} {Ln}_{0}}{2} ( 1 + \frac{2}{3} \frac{X}{{R}_{0}} ) {( \frac{d E}{d X} )}^{- 1} .$$

Again, dE/dX is calculated using SRIM for a particles with energies up to 4.2 MeV in aluminum. One factor that enhances the low energy part of the spectrum is the ⁴He(²⁷Al,²⁷Al)⁴He recoil process, similar to the process of Am—Be neutron source.

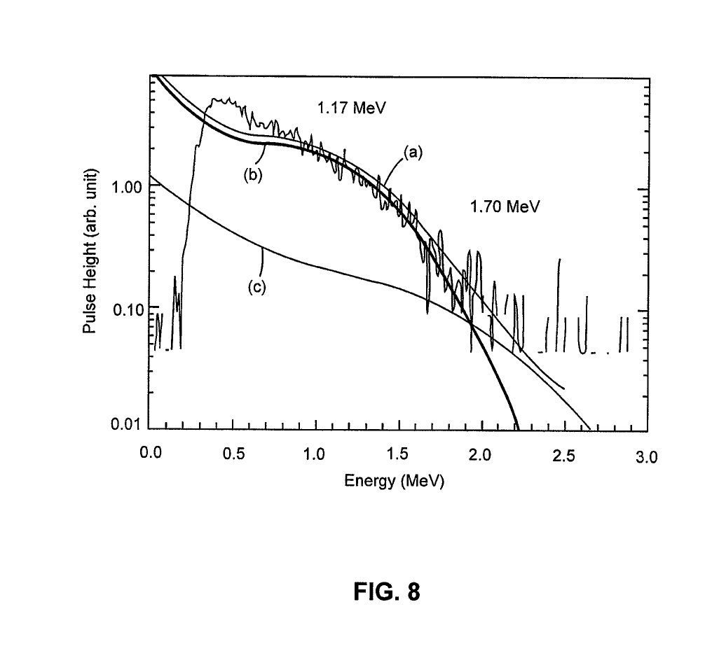

The ¹⁷N neutron spectrum in FIG. 6 is also fitted with a function that is the sum of two instrumental functions (curve (a)) at 1.17 MeV (curve (b)) and 1.70 MeV (curve(c)), shown in FIG. 8. The relative height (proportional to the total area of the instrumental function) of the 1.17 MeV was chosen to be six times that of the 1.70 MeV, consistent with several measured relative intensities ranging from 5 to 8.8. The relative resolution R was chosen to be 0.80. R=0.80 is more than twice the line width from a single tube (R=0.30). The possible explanation is that the gains from individual tubes (there are six of them to form the present detector) are not matched.

The foregoing description of the invention has been presented for purposes of illustration and description and is not intended to be exhaustive or to limit the invention to the precise form disclosed, and obviously many modifications and variations are possible in light of the above teaching. The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. An apparatus for measuring neutrons in the presence of γ-radiation, comprising:
at least one gas drift tube, each of said at least one drift tubes having an anode, for detecting neutrons and generating electrical pulses on the anode thereof responsive to said neutrons;
a charge-sensitive preamplifier for receiving electrical pulses from said at least one drift tube;
a positive high voltage power supply for providing the bias to said anode of said at least one drift tube;
a field-programmable gate array for receiving amplified electrical pulses from said preamplifier, and selecting chosen pulses;
a waveform digitizer for receiving pulses chosen by said gate array, and digitizing the received pulses; and
a processor for receiving and processing digitized pulses from said waveform digitizer, and for directing said gate array to receive electrical pulses;
whereby pulse heights and rise times are generated from the digitized electrical pulses.

2. The apparatus of claim 1, wherein said waveform digitizer comprises an analog-to-digital converter.

3. The apparatus of claim 1, wherein said gas drift tube comprises a CHₓ drift tube.

4. The apparatus of claim 1, wherein said gas drift tube comprises a Helium-4 drift tube.

5. The apparatus of claim 4, wherein said Helium-4 drift tube comprises Helium, Argon, CF₄, and C₂H₆.

6. The apparatus of claim 4, wherein said Helium-4 drift tube is operated at a pressure of approximately 11 bar.

7. The apparatus of claim 4, wherein said anode bias is approximately 2 kV.

8. The apparatus of claim 4, wherein said neutrons have energies between about 1 MeV and about 10 MeV.

9. The apparatus of claim 2, wherein said preamplifier, said field-programmable gate array, said analog-to-digital converter, and said processor are co-located on a single circuit board.

10. A method for measuring neutrons in the presence of γ-radiation, comprising:
biasing the anode of at least one gas drift tube responsive to the neutrons to a positive high voltage, such that electrical pulses are generated on the anode;
amplifying the electrical pulses using a charge-sensitive preamplifier;
selecting chosen amplified electrical pulses;
digitizing the selected electrical pulses; and
receiving and processing the digitized electrical pulses;
whereby pulse heights and rise times are generated from the digitized electrical pulses.

11. The method of claim 10, further comprising the step of analyzing the resulting pulse height information and the rise time from the digitized pulses using software.

12. The method of claim 10, wherein said step of selecting chosen amplified electrical pulses is performed using a field-programmable gate array.

13. The method of claim 10, wherein said step of digitizing selected electrical pulses is performed using an analog-to-digital converter.

14. The method of claim 10, wherein said step of receiving and processing the digitized electrical pulses is performed using a processor.

15. The method of claim 10, wherein the gas drift tube comprises a CHₓ drift tube.

16. The method of claim 10, wherein the gas drift tube comprises a Helium-4 drift tube.

17. The method of claim 16, wherein the Helium-4 drift tube comprises Helium, Argon, CF₄, and C₂H₆.

18. The method of claim 16, wherein said Helium-4 drift tube is operated at a pressure of approximately 11 bar.

19. The method of claim 16, wherein the neutrons have energies between about 1 MeV and about 10 MeV.

20. The method of claim 10, wherein said step of selecting chosen amplified electrical pulses is performed using a field-programmable gate array, said step of digitizing selected electrical pulses is performed using an analog-to-digital converter, and said step of receiving and processing the digitized electrical pulses is performed using a processor, further comprising the step of co-locating the preamplifier, the field-programmable gate array, the analog-to-digital converter, and the processor on a single circuit board.
